(19) United States
(12) Patent Application Publication
(10) Pub. No.: US 2024/0394805 A1
(43) Pub. Date: Nov. 28, 2024

(54) AUTOMATED LAST MILE SOCIAL MEDIA CONNECTIVITY

(71) Applicant: Rajgopal BHANDARY, Bangalore (IN)

(72) Inventor: Rajgopal BHANDARY, Bangalore (IN)

(21) Appl. No.: 18/686,336

(22) PCT Filed: Nov. 1, 2022
(86) PCT No.: PCT/IN2022/050959

§ 371 Date: Feb. 23, 2024

(30) Foreign Application Priority Data
Dec. 22, 2021 (IN) 202141060103

(51) Int. Cl. G06Q 50/00; G06K 7/14

(52) U.S. Cl. CPC G06Q 50/01; G06K 7/1413

(57) ABSTRACT

A system and a method for automatically connecting one or more buyers of a business onto a social media network. The system includes a social media network comprising a plurality of computing devices connected through a back-end server. The back-end server comprises a social media platform having a plurality of business pages, each owned by the respective business. The social media network further includes one or more access applications, each configured onto one of the computing devices, and is adapted to enable an access of the social media platform therethrough. The system further includes a product barcode generation module adapted to configure a social media connectivity barcode on each of the product of a business. In operation, when a buyer scans the barcode of a product onto a first computing device, the back-end server automatically installs and/or open a first access application, creates a buyer profile and connects it to the social media page of the business.

### TECHNICAL FIELD

The present subject matter relates generally to computer networks, and particularly to social media network for businesses.

### BACKGROUND

Over the past few decades, there has been a dramatic rise in use of social media networks in daily life span of each individual. Social media network is a community of members or other individuals that share similar values or interests. Each member typically comes with a personal profile, which may contain demographics, psychographics, or professional information. Each member may have no, a single, or a plurality of connections or relationships with other members within the social network. Each member may engage in activities, such as email communications, information sharing, etc., with other members. Further, current social media network companies have extended the possibility of various business support activities such as creation of company pages that provides the business with various advantages like user tracking based on browsing behavior & buying patterns; social networking with customers; embedded advertisements; affiliate advertisements for promotions; online shopping, online auctions, bidding, and so on, thereby creating limitless opportunities for the users to help them expand their business, sales and reputation on a local as well as global scale.

For the same reasons, every business has embarked their presence on various social media platforms for various reasons such as for lead generation, support services, as well as general marketing of the business. In all, the businesses tend to achieve a last mile connectivity to their consumers/customers through such social media platforms.

Similarly, the consumers/customers also want connectivity with the businesses such as product manufacturers, for various reasons such as product advisory, support & services, and various other reasons, as deemed obvious in a business-consumer relationship.

However, the current structure of social media platforms is still not completely optimized for business. For example, conventionally, the social media platforms depend on personal contact for connecting/networking. While it is easy to connect with known contacts or related contacts, it is difficult to connect with unknown relations. This drawback of existing social media sites allows limited advantages for industry/companies. Further, conventional social media platforms do not provide a systematic tool to connect with the customer/last mile in a social media environment. Companies can create a page on social media platforms, but this does not guarantee that all customers of the company will visit and follow the page. Also, member users who have purchased products from the company, could not benefit from loyalty programs, targeted advisory, or direct communication with the company. Moreover, the user of conventional platforms still needs to use a computer network, such as the World Wide Web (Internet), going through third-party blogs; various video websites and so on, for gathering various information related to products/services. While the above approaches may work to locate the particular information, content or product being sought, these and most other known approaches are inefficient, time-consuming, and may not be capable of locating the precise information the user is seeking.

Therefore, it is seen that available SaaS mostly stops at purchase activity but fails to engage last mile in a social media environment. Without a systematic process of connecting to the last mile, existing SaaS fall short in developing CRM strategies at the end consumer level. For the same reasons, businesses are still dependent on sales personnel for achieving a last mile connectivity with the customers/consumers.

Such a process while requiring a dedicated supply chain personnel management is cumbersome, costly, highly inefficient and utilizes a lot of resources of the businesses. Moreover, such a heavily personnel reliant connectivity with the consumer is not preferred by the business since as soon as the salesperson leaves the company, the connectivity for the company may be lost and therefore, leading to possible loss of the customer.

Accordingly, there is a well felt need to provide a system and method that could efficiently connect the customers with the business on a social media platform automatically without majorly requiring the activity of sales professional, and still providing all the benefits of the current social media platforms to the business.

### SUMMARY

In one aspect of the present subject matter, a system to automatically connect stake holders such as end consumers, buyers and/or dealers with the business and/or company employees on a social media platform such that various information, advisory and/or guidelines related to the products may be shared with ease amongst the stakeholders, in real time, is disclosed. The system includes a social media network comprising a plurality of computing devices connected through a back-end server. The back-end server comprises a social media platform having a plurality of business pages, each owned by the respective business. The social media network further includes one or more access applications, each configured onto one of the computing devices, and is adapted to enable an access of the social media platform therethrough. The system further includes a product barcode generation module adapted to configure a social media connectivity barcode on each of the product of a business. In operation, when a buyer scans the barcode of a product onto a first computing device, the back-end server automatically installs and/or open a first access application, creates a buyer profile and connects it to the social media page of the business.

In an embodiment, the system further includes connecting one or more stake holders of the business to the social media page of the business.

Generally, the one or more stake holders comprises authorized dealers, distributors, employees, sales agents of the products of the business

Preferably, the connection with the stake-holders and end-buyers allows communication therebetween through the social media platform

Further preferably, the communication includes one or more of but not limited to real time interaction for the purpose of advisory & support, sharing loyalty programs, technical support, and advertisement.

Potentially, the social media platform comprises one or more social media applications and/or modules configured onto the back-end server.

Particularly, the first access application installed onto the first computing device is adapted to enable an access of the social media platform by an end-customer.

Further, the second access application installed onto one or more second computing devices is adapted to enable an access of the social media platform by one or more business users.

Optionally, the bar-code generation module is positioned onto a business facility and is adapted to create a unique barcode for each product.

Further, the unique barcode on each of the product is configured to install and/or open a first access application onto the computing device of the end user.

Furthermore, the opening of the first application is followed by automatically opening and/or creating a buyer's profile and connecting it to with the business page of the product's company.

Generally, the social media platform may include one or more third party applications from one or more content creators to enable and/or provide additional utility and/or content for the users thereof.

In another aspect of the present disclosure, a method of automatically connecting one or more end-customers with the product's business social media page is disclosed. The method includes creation of one or more business pages onto the social media platform. The method further includes configuring a barcode onto each of the product of the business and linking it with the company's social media business page. The method furthermore includes an installation/opening of a first access application so as to identify the product and all other fields attributed to the product followed by connecting the user with the social media page of the product's company. Such a connection enables an interaction between plurality of stakeholders of the company and the end-buyers for various purposes such as including but not limited to real time support, technical support, advisory, marketing and the like.

The details of one or more implementations are set forth in the accompanying drawings and the description below. Other aspects, features and advantages of the subject matter disclosed herein will be apparent from the description, the drawings, and the claims.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 illustrates a block diagram of a system for automatically connecting various stake-holders of a business onto a social media platform in real time in accordance with an embodiment of the present subject matter.

FIG. 2 illustrates an exemplary back-end server in accordance with one embodiment of the present subject matter.

FIG. 3 illustrates a flow chart depicting a method for automatic connection between an end-consumer and the business in accordance with an embodiment of the present subject matter.

FIG. 4 illustrates a flow chart illustrating a method of registering a company on a social media platform in accordance with an embodiment of the present subject matter.

FIG. 5 illustrates a flow chart illustrating a method of allocating a barcode to a product, in accordance with an embodiment of the present subject matter.

FIG. 6a illustrates an exemplary view of dashboard displaying business information in accordance with an embodiment of the present subject matter.

FIG. 6b through FIG. 6g illustrate different views of an exemplary second access application belonging to a company user in accordance with an embodiment of the present subject matter.

FIG. 7 illustrates an exemplary view of first access application belonging to an end-customer in accordance with an embodiment of the present subject matter.

FIG. 8 illustrates a data flow diagram of a system for automatically connecting last mile customers onto a social media platform in real time in accordance with an embodiment of the present subject matter.

FIG. 9a illustrates a flow chart illustrating a method of displaying and advertisement of the business in accordance with an embodiment of the present subject matter.

FIG. 9b illustrates a data flow diagram depicting remote desktop process in the system for displaying the advertisement of the business via the platform in accordance with an embodiment of the present subject matter.

### DETAILED DESCRIPTION OF DRAWINGS

The present subject matter is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternate and suitable approaches to implement the functionality of any detail described herein. Therefore, any approach may extend beyond the particular implementation choices in the following embodiments described and shown.

Embodiments of the invention are directed to methods, computerized systems, and computer-readable media for use in enabling a social media connection between a business and various stakeholders including end-customer through one or more communication devices that may be utilized by a variety of product and supply chain organizations. In a preferred embodiment, the present application discloses a system and method for automatically registering an end-customer onto the social media page of the business when product of the company is scanned through a client access application. Particularly, the system allows a real time communication between one or more users, on the basis of a barcode scanned by the buyer/customer and accessed onto the access application thereof. A buyer/customer profile is created on the backend server and a list of buyer is maintained in the connection list of the business for future use by the business. Thereafter, the connection is utilized by the business for various purposes such as sharing technical advisory related to the product, providing services to the customer, sharing marketing material and so on. The system is further adapted to automatically send push notifications to the end customer in a real time. The one or more access applications are generally provided in the form of a GUI application that could be installed on a communication device. The access application may be in the form of a mobile application in an embodiment. However, in other embodiments, the system may be in form of a web-based automated service accessible on a generally known computing unit.

In an embodiment, the system of present subject matter is adapted to identify and connect customers with social media page of a company. Further, the access application may also be utilized in combination with another utility onto the communication device for various purposes for example but not limited to, contacting/calling the customer, any other stakeholder related to the supply chain, and the like. It is to be understood that unless otherwise indicated, this invention need not be limited to applications for farmers/agricultural application. As a person of ordinary skilled in the art would appreciate, variations of the invention may be applied to other possible supply chain business/industry in any other field of daily life such as within financial services such as a banking industry, investment industry, stock trading, mortgage industry, various services and products. Moreover, it should be understood that embodiments of the present invention may be applied in combination with various other social media applications such as user tracking based on browsing behavior & buying patterns; social networking with customers; embedded advertisements; affiliate advertisements for promotions; online shopping, online auctions, bidding, and so on, thereby creating limitless opportunities for the business to help them expand their business, sales and reputation on a local as well as global scale.

The terms “user,” “end user,” “consumer,” “customer,” “participant,” “buyer,” and/or the plural form of these terms are used interchangeably throughout herein to refer to those persons or entities capable of accessing, using, being affected by and/or benefiting from the tool that the present disclosure provides for the rewards program described herein. This includes both individual consumers and corporate customers such as, for example, small businesses.

It must also be noted that, as used in this specification and the appended claims, the singular forms “a,” “an” and “the” include plural referents unless the context clearly dictates otherwise. Thus, for example, the term “a data-source” is intended to mean a single data-source or a combination of data-sources, “an API” is intended to mean one or more API for a same purpose, or a combination of API for performing different program executions.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

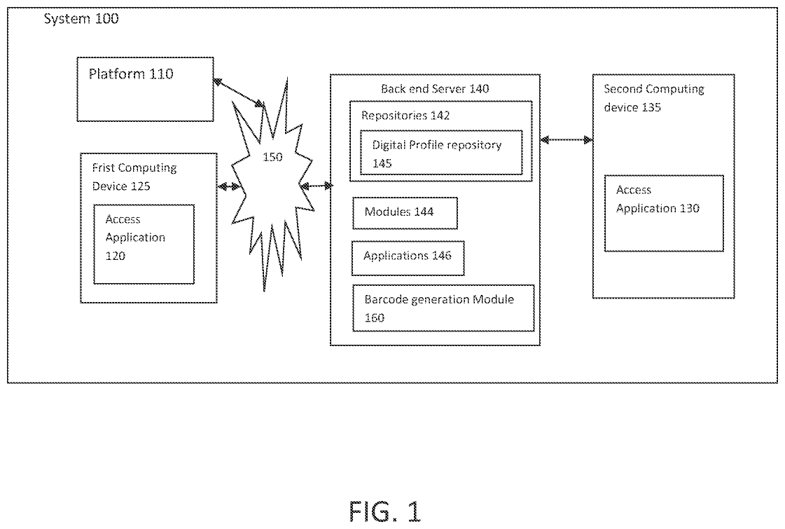

FIG. 1 illustrates a block diagram of a system 100 for automatically connecting stakeholders of a product supply chain such as manufacturer, dealers, end-customers/consumers, and the like, on to a social media network in accordance with an embodiment of the present subject matter. Particularly, the present invention addresses the foregoing described problems of enabling on-line real-time interaction between farmers and business users such as agriculture product companies, dealers and the like by using an online computer network such as the Internet and will be described in that context. It will be appreciated, however, that this is illustrative of only one utility of the invention and that the invention has applicability to other areas and problems.

The system 100 includes a social media network 110 comprising one or more back-end servers 140 connected to a plurality of stake-holders and/or business users through a plurality of computing devices 105 including one or more first computing devices 125, and one or more second computing devices 135. The back-end server 140 includes the social media platform 110 connecting the plurality of stakeholders, accessible through a corresponding access application, namely a first client application 120, a second client application 130, enabling an interaction therebetween. In some embodiments, the first application 120, and the second application 130, may at least partially reside on the first communication device 125 and the second computing device 135, and each facilitates a communication with the backend server 140. In some instances, the access applications 120, 130 may be downloaded from the backend server 140 and/or any other possible sources and installed onto the corresponding computing device 125, 135. Further, in such instances, the applications 120, 130 may be in form of different versions selectable in accordance with the type of communication device. For example, a smartphone application is further divided into an android and/or an iOS application, a software application downloadable on laptop/computers, and the like. Any and all such variations are contemplated to be within the scope of embodiments of the present invention.

Each of the access applications 120, 130 is programmed to provide a GUI that presents digital content retrieved over the internet from the social media platform 110 and receive user inputs. The first client application 120 is adapted to be installed on the one or more first computing devices 125, and is associated with an end customer, such as a farmer, customer of a product, or the like. The second client application 130 is adapted to be installed on a second computing device 135, and is associated with one or business users such as sales professional, dealers, distributors, support team, and the like. The system 100 of the present subject matter may be used to connect and network companies supplying products and dealers selling the product with last mile/farm gate end users/customers, in a social media environment. Once the network with farmers/end-customers is established, the companies can deliver advisory for crop cultivation. The companies can also deliver loyalty programs to farmers should the company have such a program. Accordingly, the farmer connection with the company through the system becomes a permanent asset for companies. Company, dealers, and farmers can exchange/share information and feedback and/or experiences. The feedback and/or experiences shared may further be used by company for advertisement purpose and hence the company is also benefitted. The companies may also connect with the dealers to display the farmer's experience as a digital advertisement in the dealer's place, thereby generating revenue for the dealer for displaying the advertisements. Therefore, farmers, companies and dealers can establish seamless communication between them.

The social medial platform 110, configured on one or more back-end servers 140 includes a plurality of repositories 142, modules 144, and applications 146 adapted to be accessed by the access applications 120, 130. The plurality of repositories 142 includes a backend server digital profile repository 145 for storing various profiles such as, of one or more business, pages user profiles for the end users and business users and a relationship profile for a relationship between the business, the first users and the second users. The plurality of repositories 142 further includes a relationship history database 147 that stores historical interactions among the various users on the social media platform 110. The plurality of application 146 includes at least an interaction application facilitating meaningful social interactions among the first and second client computing devices 125, 135 respectively.

The social media platform 110 is configured to receive one or more registration request from one or more business for creating a business page having personalized content, such as products shop, information/content related to products and/or services to be shared with the consumers/customers/stakeholders of the supply chain of the product of the business. The information may include one or more media content such as including but not limited to underlying media content that is combined with other, business content to provide personalization to the underlying media content for one or more users. Media content can include, for instance, music and/or video excerpts, movie excerpts, music files, images, television clips (ex. SNL skits), product advisory videos, and/or other types of marketing materials. Further, the company pages may be relationally connected to the first users and the second users associated thereto, such that the information may be shared with them.

The social media platform 110 of the present subject matter includes one or more company content pages, and a set of the first and/or second users who are stakeholder of those social networks, each being represented by a corresponding profile page. The company content pages may also be hyperlinked to the profiles of the users currently being a member of the social networks corresponding to the pages. In other embodiments, the social media platform 110 is in the form of a conventionally known social media environment service adapted to be coupled with various third-party content providers such as social network providers 111, commercial content feed providers 112 (including RSS feeds), commercial audio/video providers 113, gaming service providers 114, and private audio-visual feeds 115. The social media platform may be coupled to the third-party providers via various known networks. Any number of different services which may be provided via social media platform 110 may be utilized in accordance with the technology provide herein.

In one aspect, when a user is registered with the social media platform 110 through the corresponding client application 125, the user is automatically matched to a business content page and is joined to the network for the same. Further, the user such as a farmer, when registered, either selects/or gets associated to receive content from the business users, for example, a seed company, a dealer and/or the like. The social media platform 110 allows for various forms of communication and content sharing amongst the people in that network, as well as to other applications on the Internet. In addition, the platform 110 allows for seamlessly launching applications 146 from within the social media environment. The applications 146 can be created by one or more content provider or selected by users of the platform. The technology thus provides a mechanism to develop and deliver targeted advisory for the product sold; design and deliver loyalty programs; share and exchange information related to the product of interest with consumer. Further, the users can form their own private content, and share among other users within their network too.

In another aspect, a business user such as a dealer also registers with the social media platform 110 through the corresponding access application 135 installed on the dealers' computing device 130. The dealer may opt-in for subscription and unlock different services available on social media platform 110. Once the dealer is subscribed, the company is notified, and monitor is set up on the dealer's place. The company may collaborate with the dealer to display the advertisements of the company, thereby generating revenue for the dealer. Therefore, company, farmers, and the dealer all are benefitted from the platform.

The system 100 further includes a barcode generation module 150 positioned onto the backend server 140 adapted to generate a barcode for each of the product of the business. In another embodiment, the barcode generation module 160 may be a separate module and is configured to generate the barcode for each of the product module. In yet other embodiments, any known convenient mechanism may be used to generate barcode for each of the product.

The computing unit including the first computing device 125 and the second computing device 135 is intended to represent various forms of mobile devices, such as personal digital assistants, cellular telephones, smart phones, laptops, tablet, notebook. The components shown here, their connections and relationships, and their functions, are meant to be exemplary only, and are not meant to limit implementations described and/or claimed in this document.

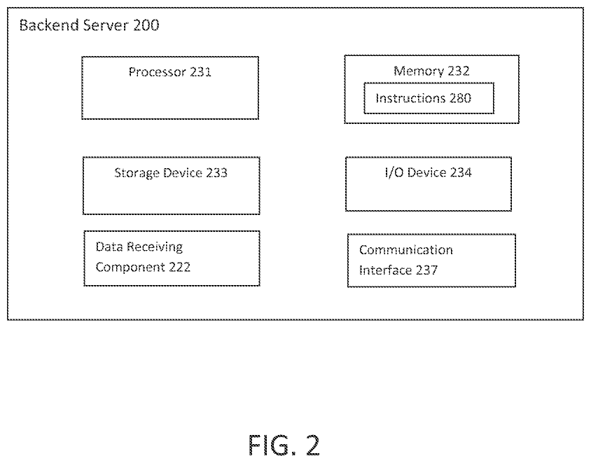

In a preferred embodiment, as illustrated in FIG. 2, the back-end server 140 is a computing device 200 having a processor 231, memory 232, a storage device 233, a high-speed interface connecting to memory and high-speed expansion ports, and a low-speed interface connecting to low speed bus, one or more input/output (I/O) devices 234. Each of the components 231, 232, 233, 234 are interconnected using various busses, and may be mounted on a common motherboard or in other manners as appropriate.

The computing device 200 is shown as including the memory 232. The memory 232 may store the executable programming instructions 280. The executable instructions 280 may be stored or organized in any manner and at any level of abstraction, such as in connection with one or more applications, processes, routines, procedures, methods, functions, etc.

The computing device 200 further includes a data receiving component 222 that may communicate wirelessly with various communication interfaces of the other computing units, through a back-end communication interface 237. The back-end communication interface 237 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, Wi-Fi, or other such transceiver (not shown). However, in other embodiments, the data receiving component 222 may use one or more application programming interface (API) connected to the computing device so as to receive datasets there from in a format acceptable by the source API and readable by the back-end server 140.

As disclosed above, the back-end server 140 can be operatively coupled to the client access applications through the communication medium 150 with the aid of the back-end communication interface 237. The communication medium 150 may be in form of Internet, an internet and/or extranet, or an intranet and/or extranet that is in communication with the Internet. The communication medium 150 in some cases is a telecommunication and/or data network. The communication medium 150, in some embodiments may be used to distribute the back-end server 140 within one or more distributed central servers, which can enable distributed computing, such as cloud computing.

FIGS. 1 and 2 schematically show the arrangement of the basic components of the system 100 of the present subject matter. However, in the construction of automated tools for social media network, secondary components such as different memories, databases, clouds, network, and other related functional components known to one skilled in the field of automated social media tools based on deep leaning methodologies, may be incorporated in the system 100. Such functional and/or supporting components are included in the present invention as long as the logical components and arrangements disclosed herein are present.

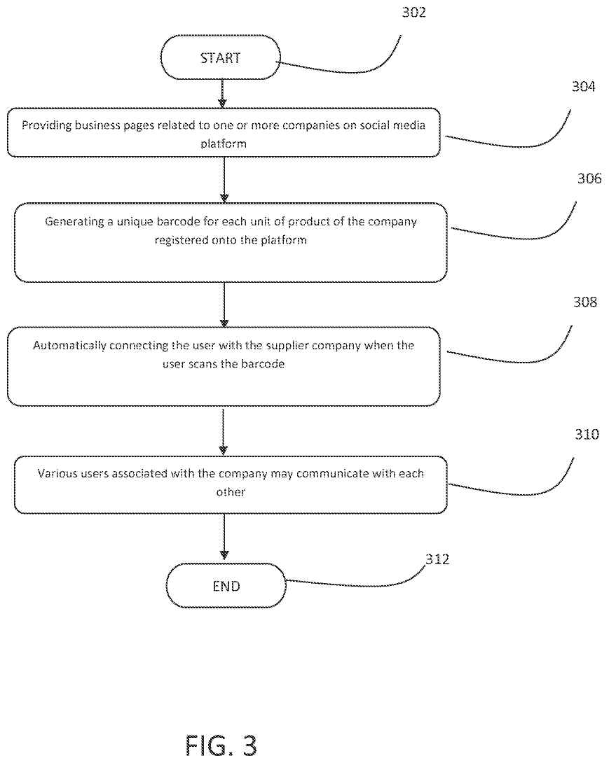

FIG. 3 illustrates a flow chart of a method for automatic connection between a last mile customer and the business in accordance with the preferred embodiment of the present subject matter. The method starts at step 302 and proceeds to step 304.

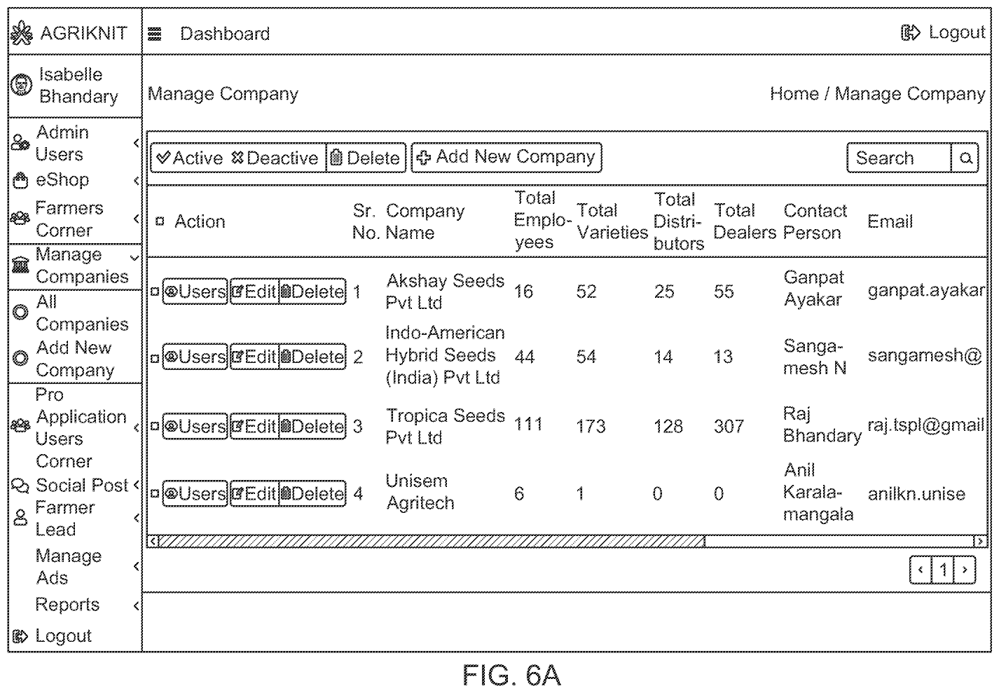

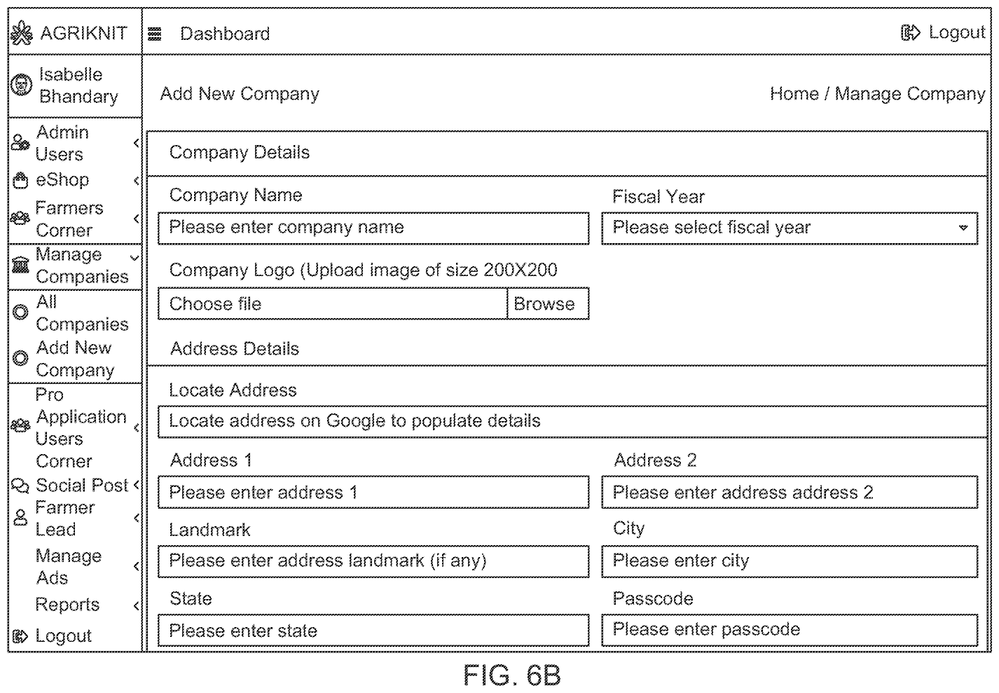

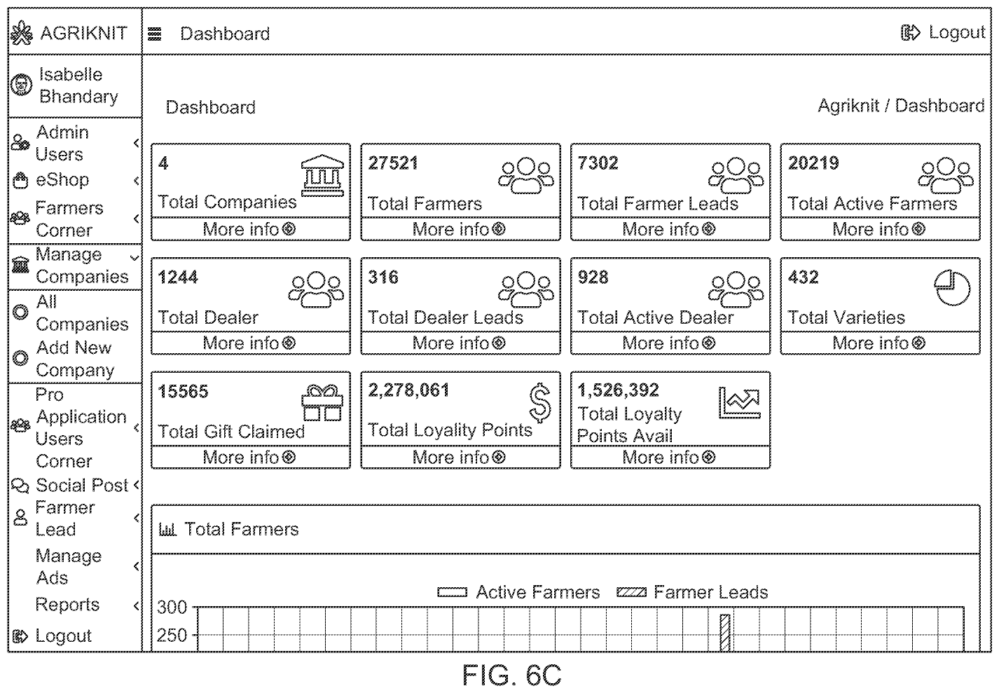

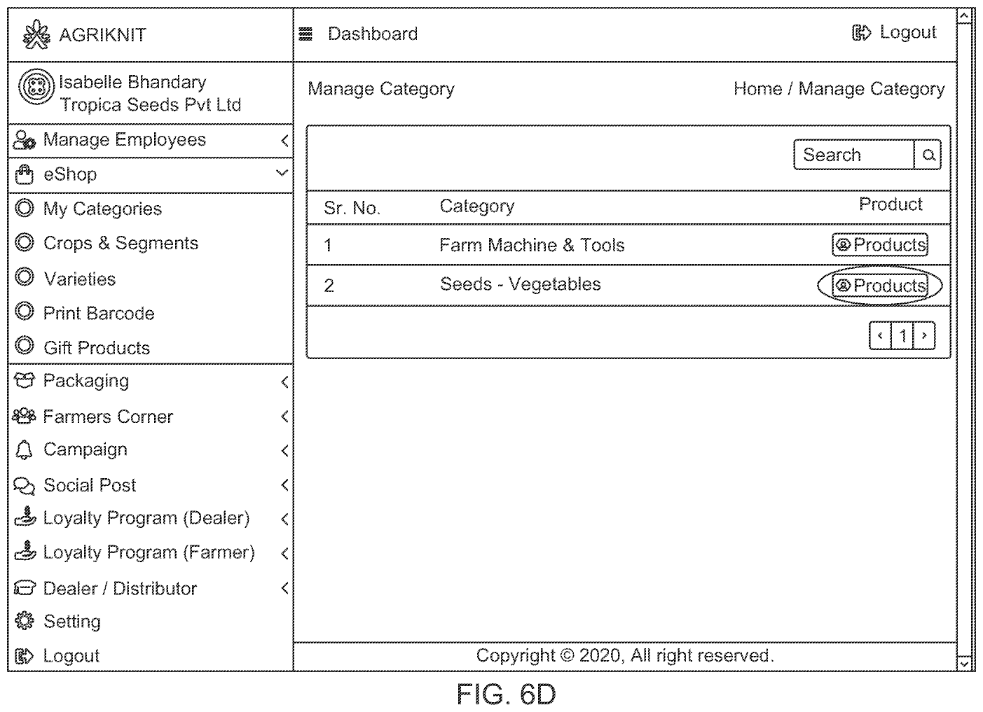

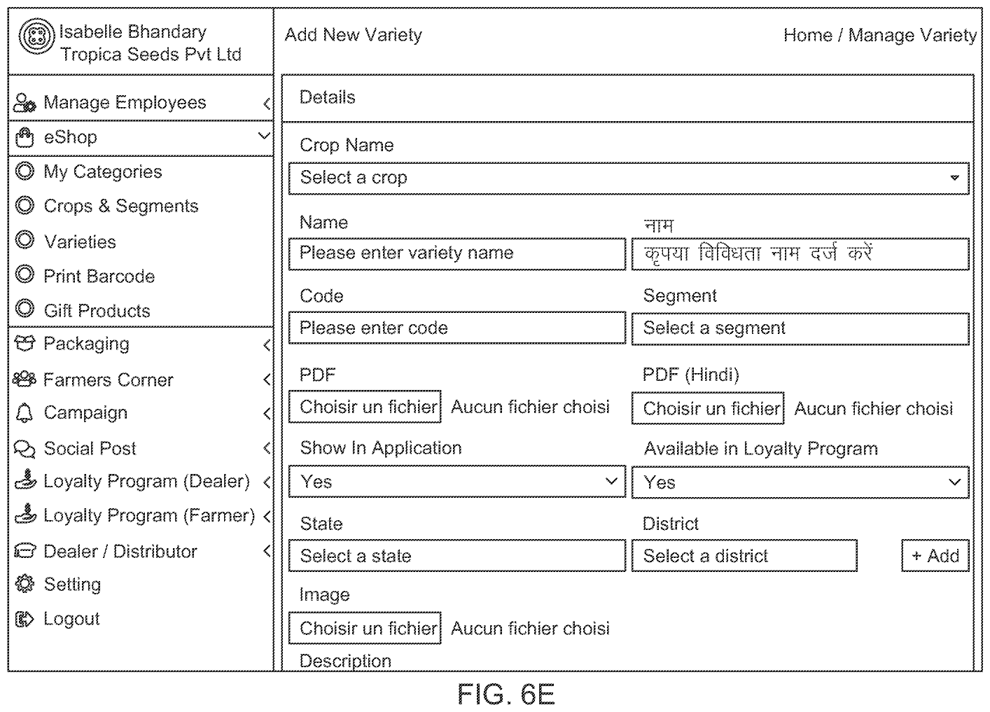

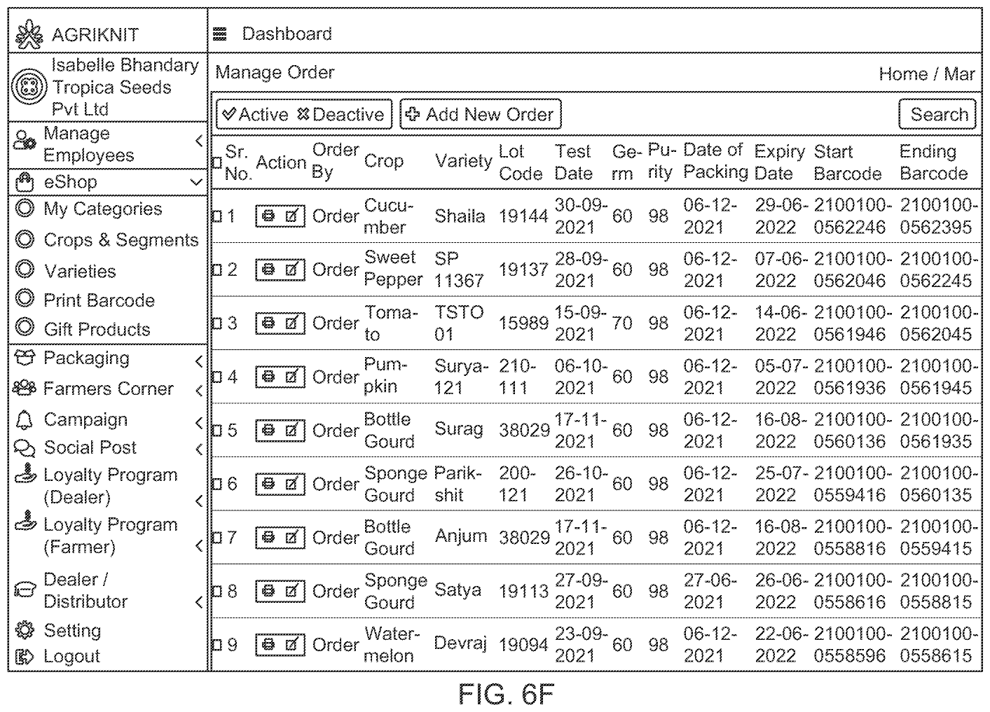

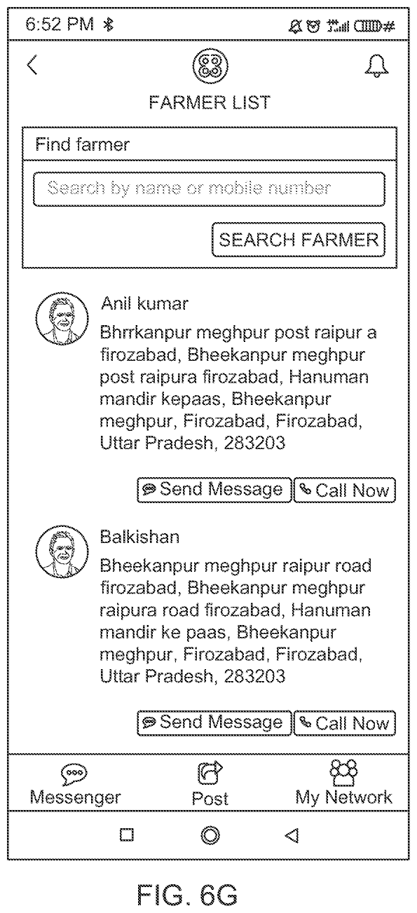

At Step 304, the social media platform 110 is provided with business pages related to one or more companies as illustrated in FIG. 6b. The business page of the companies includes information such as company name, total number of employees, total number of variety of products, number of distributors or dealers the company, contact person and corresponding contact information such as email ID, phone number etc. The company information may further include logo of the company, address of the company, fiscal year, turnover and the related information which may be required by the stakeholders. The list of the companies and the corresponding business pages are available on the social media platform 110. Similarly, the social media platform 110 is provided with the list of customers/end users and is added to the company information.

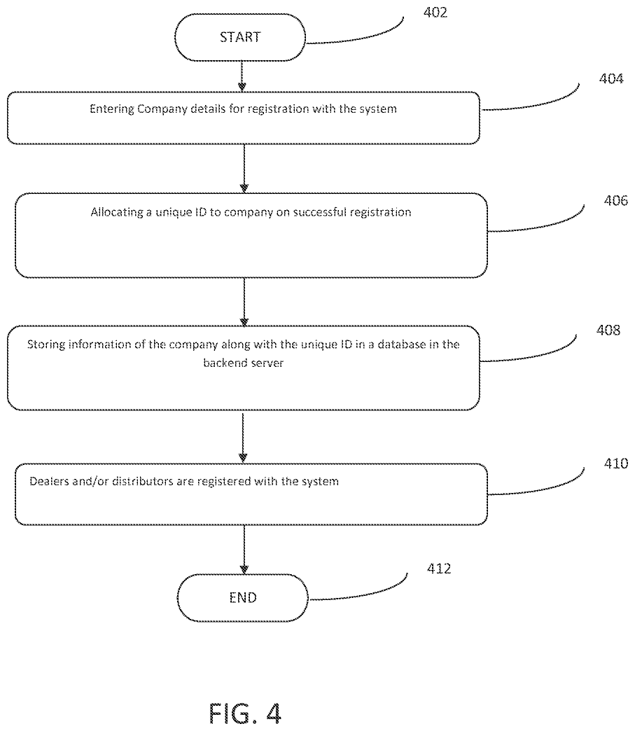

Once the profile of business is created, as illustrated in method 400 shown in FIG. 4, on the social media platform 110, the method proceeds to step 306 where one or more barcode generating module 160 is utilized to generate a unique barcode for each unit of product of each of the company registered onto the platform 110. While generating the barcode for a product, the information related to the product is added to describe the product. The information includes the product name and variety, lot code for a product, purity of the product, date of packing and expiry date of the product, starting barcode and ending barcode in the lot code. For example, if a company is selling different variety of seeds such as cucumber, pumpkin, tomato, sweet potato etc., then for each type of vegetable, the variety of seeds is added along with the lot code. Once all the information related to the seeds or product is added, the barcode is allotted to the product. Such a barcode is adapted to be scanned by users of the first and/or second access applications 125, 135, so as to identify the product and all other fields attributed to the product such as details of the product, advisory for the product, loyalty program for the product. As soon as the product is sold to an end-customer or buyer, the details of the buyer may be added by seller, dealer or an employee of the company as a lead in the second application 135, thereby creating a buyer list on the platform. As illustrated in FIG. 6g, the buyer's list may further be used to search any particular buyer to be connected for pushing any loyalty program or advertisement which may be helpful to the buyer.

At step 308, when the barcode is scanned by one of the users, the access application 125 identifies the product and the user is automatically connected with the supplier company. In some embodiments, where the user does not have the access application 120 installed onto the computing device 125, the back-end server automatically installs the first application 120 thereon, followed by creating user's profile and connecting it to the company's social media page onto the platform 110.

Thereafter, at step 310, various second users/business users associated with the company may be able to interact and/or share messages with each other via various communication means provided by the social media platform. The customers may also share their feedback or experience related to the purchased products on the company's business page. The method terminates at step 312.

FIG. 4 illustrates a flow chart of a method of registering a company onto the social media platform 110 in accordance with the preferred embodiment of the present subject matter. The method starts at step 402 and proceeds to step 404, where social media platform 110 requires entering of various company details as illustrated in FIGS. 6a and 6b, such as name of the company, contact person details, in a registration form. Once the company is registered successfully, a unique ID is allocated to the company by the system at step 406. The information of the company along with the unique ID is stored in a database in the backend server 140 at step 408. Once the company is registered with the platform 110, it appears on a UI dashboard. Further, the UI dashboard also displays the data of total number of businesses registered on the platform, total end customer, total loyalty points rewarded and redeemed and more, as illustrated in FIG. 6c. Further the dealers and distributors are also registered with the company content page, via their corresponding second user applications at step 410. The method terminates at step 412.

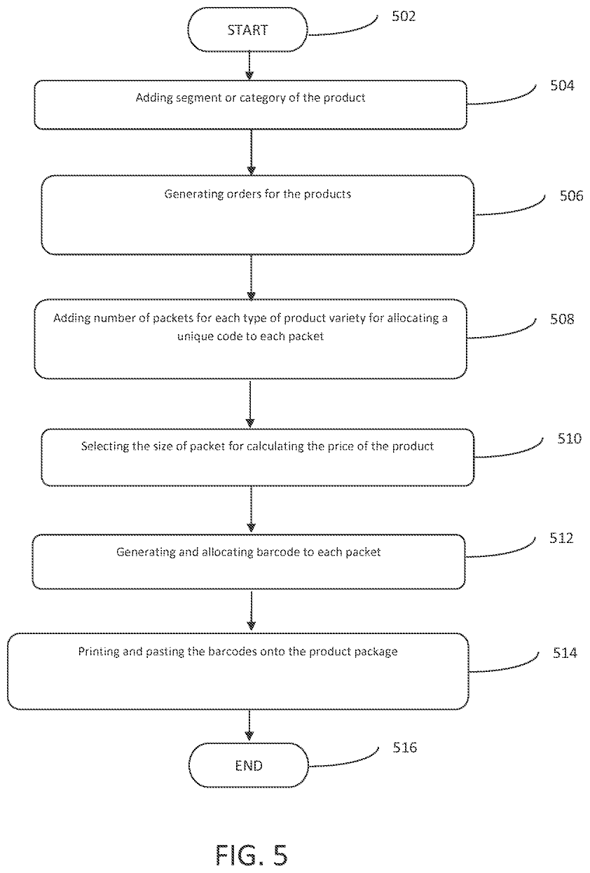

FIG. 5 illustrates a flow chart of a method 500 of allocating a barcode to a product during the workflow of products onto a company's page, in accordance with the preferred embodiment of the present subject matter, where once the company is registered; an administrator is allocated to the company's backend for adding information to the company's database on social media page. The administrator is provided with various privileges including addition of new products, such as seeds in case of agricultural company. The method starts at step 502 and proceeds to step 504 where administrator adds segment/category of products as illustrated in FIG. 6d, wherein the type of product is selected. The type of product may include seeds, farm machine or tools, fertilizer, insecticide or pesticide or any other related products of the company. The administrator adds product to the segments of the products as illustrated in FIG. 6e. While adding a new variety of product, details of the product such as name and variety of crop, type of product, image of product, loyalty program, if any, available with the product, description of product, location of the product and more are added.

The administrator is further allowed to create/generate/receive orders for the products which may be saved within the repository 142 of the back-end server 140 at step 506 (as illustrated in FIG. 6f). Thereafter at step 508, the platform 110 prompts for the number of packets for each type of product variety and segment in order to generate and allocate a unique code to each packet. Once the number of packets is added, the method proceeds to step 510 where the system prompts for the packet size, wherein the administrator is allowed to select the size of the packet in order to calculate the price of the packet and hence the loyalty points, if applicable. The system then proceeds to step 512, wherein barcode is generated and allocated to each packet, thereby completing the ordering process. Thereafter, at step 514, such generated barcodes are printed and pasted onto the product packages. The method terminates at step 516.

Further, FIGS. 6a & 6b illustrates different views of an exemplary second access application belonging to a business. The administrator/operator/user of the business registers and adds business details on to the platform. FIG. 6c represents a schematic dashboard representing the data related to the consumer on the company portal. FIG. 6d through 6f illustrate different views of an exemplary second access application belonging to the company administrator to add product varieties and generate the barcode for each product. Further, FIG. 6g illustrates the search for a farmer in the farmer's list, wherein the farmer may be searched for pushing the customized advertisement. Further, the farmer list includes all the details of the farmers in the database, who may be contacted, even when the sales person has left the company.

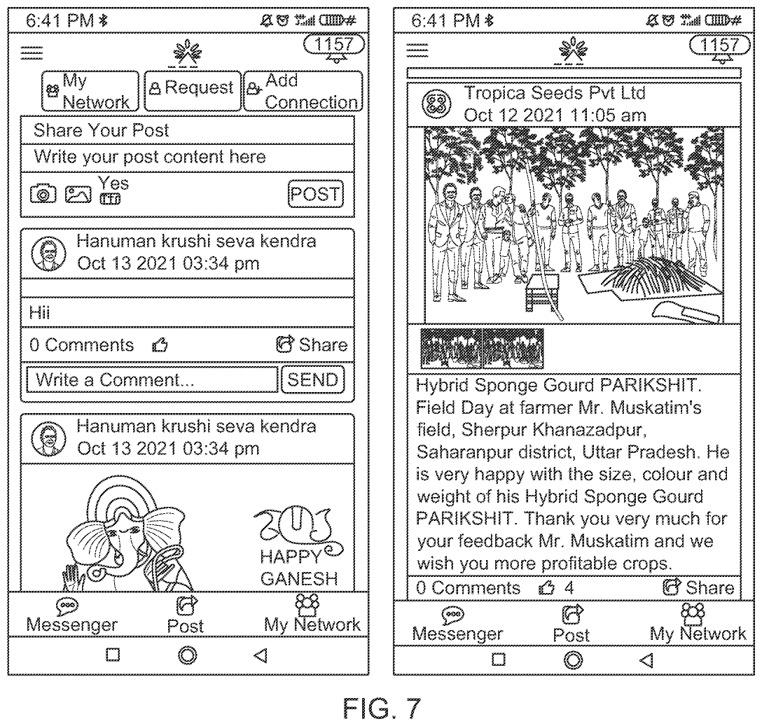

FIG. 7 illustrates an exemplary first access application 125 belonging to the end-customer. FIG. 7 depicts the feedback posted on the social media platform by a consumer/farmer along with the picture or video of his field regarding the seeds (product) of the company used by him. The feedback or customer experience may be used as an advertisement by the company for promotion. Further, such posts are always helpful in justifying the quality of the product for both the company and other buyers or customers looking for buying the same type of product.

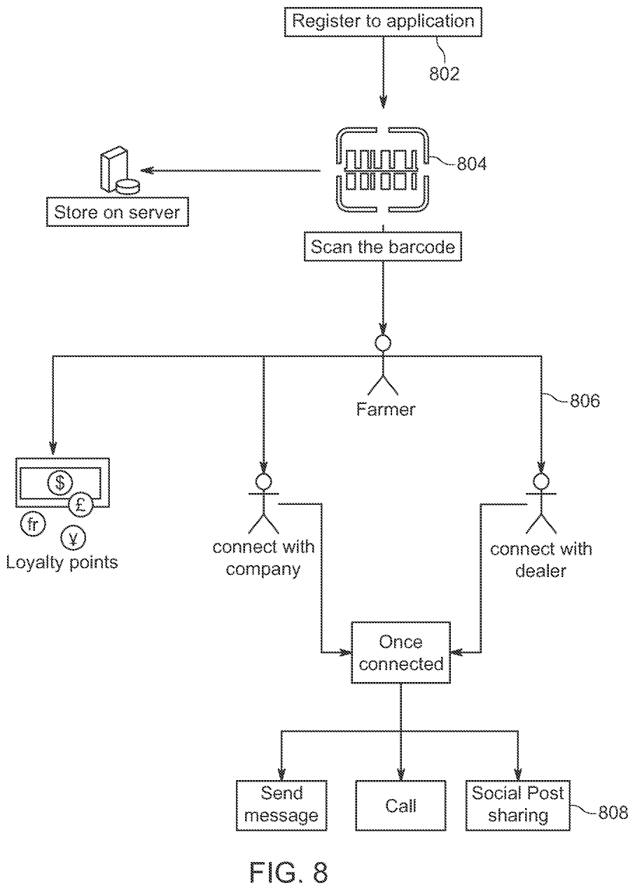

FIG. 8 illustrates a data flow diagram 800 of a system for automatically connecting last mile customers onto a social media platform in a real time in accordance with an embodiment of the present subject matter wherein the end-customer, i.e., a farmer downloads access application 125 and registers with the social media platform 110 via the access application 125 at step 802. Sometimes, the farmer may not download the access application 120 on first computing device 125, then the farmer's details are added to the system database 142 to be used as the lead for the business for connecting with the farmer for future products and/or advisory. However, whenever the farmer downloads the app in future, the advisory or other notifications are pushed on to the farmer via the access application 120. Proceeding to step 804, the farmer purchases the product and scans the barcode of the product. The information related to the farmer is added and/or retrieved in the system database 142 by the dealer/seller/distributor. Further, at step 806, the system 100 calculates the loyalty points for the farmer when the product barcode is scanned and stores the loyalty points in the database 142 along with farmer's details. The farmer details may include but are not limited to name and address of the farmer, contact number etc. Based on the farmer's information, the product and advisory details, loyalty programs, customized advertisements on the product and the like are pushed or notified to the farmer. Further, the farmer is also connected to the business and the dealer or distributor, which allows the farmer to find dealers/distributors on the platforms in future for the product required and may contact them based on the requirement. The farmer may also identify based on the other customer's feedback or experience or ratings posted on the platform. The farmer may connect to the company directly for the query on any new product or advisory regarding the earlier purchased product. The farmer may further connect to the company for any feedback and/or experience related to the product, or the new product. At step 808, the business or the dealer may use the farmer's lead and or the information for calls, sending message to the customer regarding advertisement of a product, sharing posts on the platform so as to update the customer regarding upcoming or advanced products. The process terminates at step 808. Further, the farmer may also share his feedback and/or experience on the social media platform 110 which is received and stored in the backend server and can be viewed by the employees of the company (as illustrated in FIG. 7). The customer's feedback/rating may be visible to other customers for reference on the quality and experience of the product. Further, the feedbacks may be beneficial for the businesses and can be used as advertisement by the business. The business may request the dealer through the platform, to post the feedbacks on visual displays at dealer's end as an advertisement.

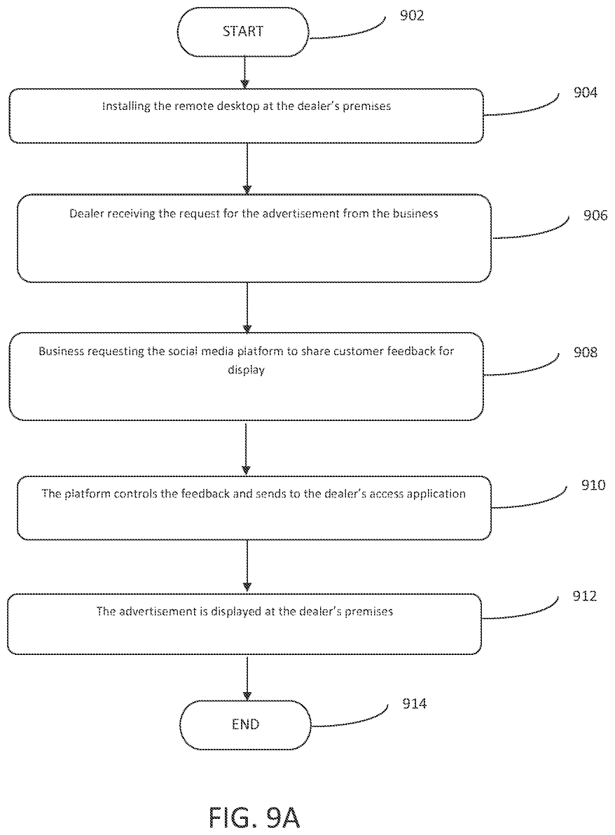

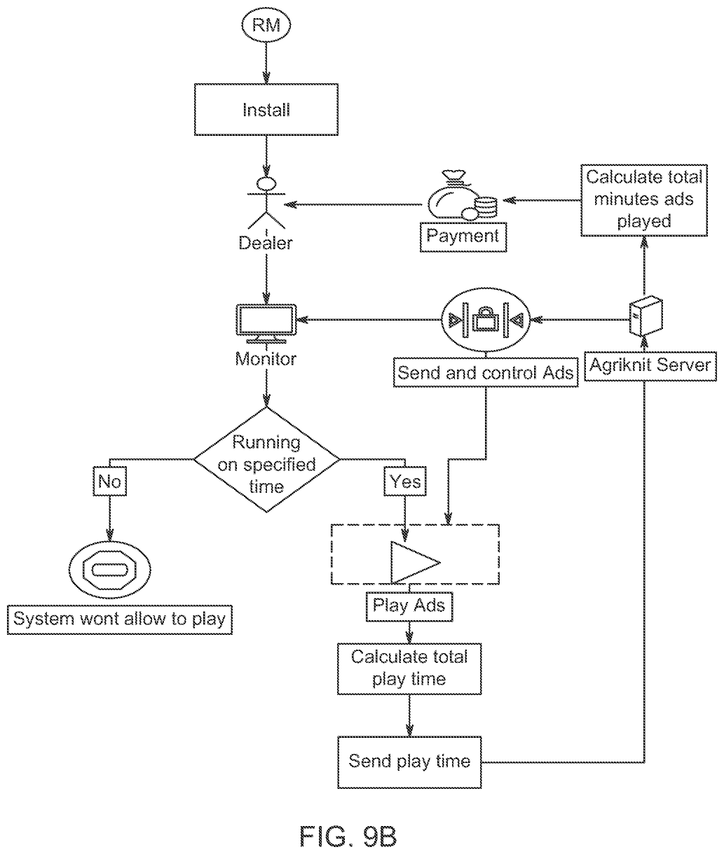

FIG. 9a illustrates a flow chart depicting a method of displaying and advertisement of the business, in accordance with an embodiment of the present subject matter. The process starts at step 902 and proceeds to step 904 wherein the remote desktop application is installed on the dealer's computing device 135. A screen such as monitor, hoarding, TV and the like is installed in the dealer's premises for displaying the business advertisement. At step 906, the dealer receives the advertisement display request from the company for the company's product via the platform 110. The companies registered with the social media platform 110 may post advertisement, which is one of the services on the social media platform 110. At step 908, while posting the advertisement, the company may also request the platform to share the customer experience (CEX) and/or feedback for display as an advertisement. The platform shares the customer feedback with the dealer for display. The platform may also earn from the business for sharing the (CEX) shared by the customer on the social media platform 110. Further, the post of the farmer on the portal is also visible to all the connections of the company on the platform. However, in order to increase the sale and to popularize the product among more to-be customers (who are not connected on platform), the business may advertise the product in a location based on customer location, who shared his experience. At step 910, the platform controls the feedback and sends it to the dealer's access application 135. The access application 135 may be configured to be connected to the display device in the dealer's premises. The example of the display device may include but is not limited to a hoarding, monitor, TV etc. The access application may be connected to the display device via wireless network which includes but is not limited to Wifi, Bluetooth, Wimax, and more. At step 912, the advertisement is displayed at the dealer's premises. The process terminates at step 914. Further, while posting advertisements, the company fills in the dealer's information such as dealer's name, address, location, slots allotted, start date and end date before making the payment for posting the advertisements. The company may chose the dealer based on various factors such as the location of the customer, who shared his experience on the portal. Once the payment is made, the update status notification is sent to the company.

As illustrated in FIG. 9b, the social media platform further approves CEX for posting advertisements when the payment is received from the company. The social media platform further notifies the dealers for displaying the advertisement of the company on a digital dashboard or the like. The server sends and controls advertisements to the dealer. In order to achieve this, the dealer downloads the access application. The dealer may opt-in for subscription and unlock different services available on social media platform. Once the dealer is subscribed, the company is notified, and the monitor is set up on the dealer's place. Once the dealer receives the advertisement, the CEX is posted as an advertisement and displayed on the remote monitor on the dealer's place.

Further, the system 110 checks if the advertisement is running on a specified time and/or allocated lots. If not, then the system does not allow the advertisement to play. If the advertisement is running on a specified time, then system allows the advertisement to play. Further the system calculates the advertisement play time and sends the playtime to the server. The server calculates the total time period, preferably minutes, for which advertisement is played on the dealer's remote monitor. Accordingly, the payment is made to the dealer for the time period for which advertisement is played on the dealer's display or remote monitor. Once the payment is made, the status is updated in the server and to the company.

In some embodiments, the communication between the user may allow various users, including business users, the end-users to participate in private, group and environment-wide messaging. In private messaging, a user can direct a message to an individual user within the social media which is not seen by other social media members. Similarly, in group messaging, a user can direct a message to a sub-group within the social media.

In some embodiments, the applications 146 can include content such an audio/visual content, written content or other types of consumable content, games, communications between users, and user interfaces from various devices. The application 146 may include applications that can be a dedicated application specific to a user device or be programmed to operate in a web browser by using standard web programming techniques. Likewise, web applications may be stored in an application store, and launched by a launcher in the social media environments platform 110. Any type of architecture which is currently utilized to provide applications to devices 125, 135 can be utilized in accordance with the present technology. When used in conjunction with shared content, for example, applications can comprise games related to the content. For example, the games may be social games accompanying sporting events.

In some embodiments, the social media platform 110 is configured to cache content/activity of its users that includes content shared in environments as well as meta-data, links and other sharing activity which occurs around the content in the social media platform 110. As users interact with others and the content, information concerning the sharing activity of the users may be stored for later consumption by other users/business, and use in implementing various features described herein, such as linking to different types of media or providing comments on the content, as described above.

In some embodiments, the communication may be in form of social feeds can include feeds from services such as Facebook®, Twitter®, Microsoft Live®, and the like. In some other embodiments, the content feed may be commercial content feed and may include information culled from various commercial news sources, or content aggregators and/or related to products of the businesses. A commercial audio/video feed may comprise network-based feeds such as YouTube®, Hulu®, or audio/visual sources broadcast. Commercial content feed may include various types of media, including audio/video, text and image information.

Various connections are set forth between elements in the description and in the drawings, the contents of which are included in the instant description by way of reference. These connections in general and, unless specified otherwise, may be direct or indirect and this description is not intended to be limiting in this respect. In this respect, a coupling between entities may refer to either a direct or an indirect connection.

In an embodiment, the method and system, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source, or a physical memory element present in the processing machine.

Various embodiments of the invention have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

The disclosed methods and systems, as illustrated in the ongoing description or any of its components, may be embodied in the form of a smart phone. Typical examples of a computing system include a general-purpose smartphone, a programmed microprocessor, a micro-controller, a peripheral integrated circuit element, and other embedded sensors, that are capable of implementing the steps that constitute the method of the present subject matter.

The programmable or computer-readable instructions may include various commands that instruct the processing machine to perform specific tasks, such as steps that constitute the method of the present subject matter. The systems and methods described can also be implemented by using only software programming or using only hardware or by a varying combination of the two techniques. The present subject matter is independent of the programming language and the operating system used in the computers. The instructions for the present subject matter can be written in all programming languages including, but not limited to, “C,” “C++,” “Visual C++,” Java, and “Visual Basic.” Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The present subject matter can also be implemented in various operating systems and platforms including, but not limited to, “Unix,” “DOS,” “Android,” “Symbian,” and “Linux.”

The programmable instructions can be stored and transmitted on a computer-readable medium. The present subject matter can also be embodied in a computer program product comprising a computer-readable medium, or with any product capable of implementing the above methods and systems, or the numerous possible variations thereof.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

The systems and techniques described here can be implemented in a computing system that includes a back-end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back-end, middleware, or front end components. The components of the system can be interconnected by any form or medium of digital data communication (e.g., a communication network). Examples of communication networks include a local area network (“LAN”), a wide area network (“WAN”), and the Internet.

The claims can encompass embodiments for hardware, software, or a combination thereof.

Although a few implementations have been described in detail above, other modifications are possible. Moreover, other mechanisms for performing the systems and methods described in this document may be used. In addition, the logic flows depicted in the figures may not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A system for automatically connecting one or more buyers of a business onto a social media network, the system comprising:
the social media network comprising:
a back-end server comprising a social media platform having a plurality of business pages, each owned by the respective business;
one or more access applications adapted to enable an access of the social media platform therethrough; and
a product barcode generation module adapted to configure a social media connectivity barcode on each of the product of the business;
wherein when a buyer scans a barcode of a product onto a first computing device, the back-end server automatically installs a first access application, creates a buyer profile and connects it to a social media page of the business.

2. The system as claimed in claim 1, further comprises connecting at least one stake holder of the business to the social media page of the business.

3. The system as claimed in claim 2, wherein the at least one stake holder comprises authorized dealers, distributors, employees, or sales agents of products of the business.

4. The system as claimed in claim 1, wherein the social media platform comprises one or more social media applications or module configured onto the back-end server.

5. The system as claimed in claim 1, wherein the one or more access application comprises a first access application adapted to enable an access of the social media platform by an end-customer.

6. The system as claimed in claim 1, wherein the one or more access application comprises a second application adapted to enable an access of the social media platform by one or more business users.

7. The system as claimed in claim 2, wherein connecting with the at least one stake-holder and end-customers allows for a communication therebetween through the social media platform.

8. The system as claimed in claim 7, wherein the communication comprises at least one of real time interaction for advisory and support, sharing loyalty programs, technical support, or advertisement.

9. A method of automatically connecting end-buyers of a business onto a social media network, the social media network comprising a back-end server having a social media platform accessible by one or more access applications, the method comprising:
creating a social media page of the business onto the social media platform;
configuring a social media connectivity product barcode on each of the product of the business; and
automatically creating a buyer profile and adding it to the social media page of the respective business when a product barcode is scanned by the end-buyer on to a first computing device,
whereby the scanning of the product barcode automatically installs a first access application onto the first communication device adapted to enable an access of the social media platform therethrough.
